(19) United States
(12) Patent Application Publication
(10) Pub. No.: US 2008/0030317 A1
(43) Pub. Date: Feb. 7, 2008

(54) Method of Improving Medical Apparatus in Order to Replace Ancillary Medical Assistance by Employing Audible Verbal Human Sounding Voices to Prompt Therapeutic Usage and Provide Guidance, Measurements, Encouragement and Response, As Needed, to the Patient, By Using Electronic Technology

(76) Inventor: Terry Keith Bryant, Singer Island, FL (US)

Correspondence Address: DANIEL S. POLLEY, P.A., 1215 EAST BROWARD BOULEVARD, FORT LAUDERDALE, FL, 33301, US

(21) Appl. No.: 11/833,787

(22) Filed: Aug. 3, 2007

Related U.S. Application Data
(63) Continuation-in-part of application No. 10/767,396, filed on Jan. 23, 2004.
(60) Provisional application No. 60/821,413, filed on Aug. 4, 2006.
(60) Provisional application No. 60/821,418, filed on Aug. 4, 2006.
(60) Provisional application No. 60/821,421, filed on Aug. 4, 2006.

(51) Int. Cl. G08B 3/00

(52) U.S. Cl. 340/505; 600/300

(57) ABSTRACT

This method comprises of a method of eliminating ancillary medical assistance by the utilization of audible, verbal simulated human sounding voices produced by electronic technology which allows the ability to supply audible, verbal instructional help, prompting, measurements and also respond to the actions the patient is taking, through a human sounding voice providing the therapeutic requirements of the medical apparatus itself. With the employment of this unique method of self instructing, electronically functioning medical apparatus, the present invention will provide assistance to both the patient and the doctor by supplying non-human assistance, and will allow the therapeutic procedures contained within the electronic hardware of the present invention to be attached to, or built within, or combined to accommodate usage of each medical apparatus, thus, eliminating the need for ancillary medical assistance.

This application is a continuation-in-part of U.S. application Ser. No. 10,767,396, filed Jan. 23, 2004, and claims priority to and the benefit of U.S. Application Ser. No. 60/821,413, filed Aug. 4, 2006, U.S. Application Ser. No. 60/821,418, filed Aug. 4, 2006, U.S. Application Ser. No. 60/821,421, filed Aug. 4, 2006 and U.S. Application Ser. No. 60/475,504, filed Jun. 2, 2003, all of the above-identified applications are incorporated by reference in their entireties.

Application: #60/475,504 filed Jun. 2, 2003 and Disclosure Document #504899 dated Jan. 15, 2002 relate to this specification herein and are incorporated by reference and the benefit of and priority to are claimed by the inventor.

### BACKGROUND OF THE INVENTION

Medical apparatuses have always been associated with a nurse, or ancillary medical assistant to help the patient or person using it to perform their therapeutic sessions, or preferred operation, in relationship to whatever medical apparatus is being used. Normally, the ancillary medical assistant will give instructions first on what the apparatus is and how it helps whatever medical need it is being applied to in relationship to the patient and then the steps of use are explained in some detail. This then leads to the ancillary medical assistant verbally instructing the patient on how to read their particular measurements being performed, such as volumes or pressures being produced by the body of the patient, if the apparatus requires such. Otherwise the ancillary medical assistant will stand over the patient and guide the patient of the technique of the therapy, such as; when to breath in or out, as an example. As with any new medical apparatus that a person is unfamiliar with, ancillary guidance must be continued throughout recovery of the patient, reminding and prompting as to when and how to use the medical apparatus, such as whether the patient should “try harder”, but not limited to these exact words, in order to improve the patient's health or medical condition.

For instance, during recuperation after surgery a patient is required to repeatedly use ventilators with special gases to help moisturize the lungs, that during an operation usually collapse. Thus, after the operation the ancillary medical assistant will tell the patient when to begin breathing in said gas, through a medical apparatus that produces the gas at the appropriate time, in order that the lungs may regain their flexibility and return to normal. Other apparatus's, but not limited to, would be the peak flowmeter, or a measuring device which is used to measure the amount of exhaled oxygen, or gas which the patient during that particular set interval is exhaling, thus, the ancillary medical assistant will tell the patient to exhale when appropriate and usually follow up with encouraging phrases such as “good job” or “let's try that again”, but not limited to these exact words. Whenever there is a need for ancillary medical assistance in conjunction with medical apparatus there is always a need for encouraging words, measurements and prompting, even if it is just the words like; “start now” or “stop”, but not limited to these exact words. However, in any event some normally audible verbal guidance or words that must be spoken by an ancillary medical assistant, so that the patient can understand the usage of the apparatus or therapy.

Most of the time it is a continual session that requires the help of an ancillary medical assistant to either tell the patient how and when to do the necessary steps for using the medical apparatus, or just checking up on the patient as to whether the patient is actually really doing the required therapeutic session required by their particular apparatus. Sometimes it may be as simple as verbally supplying the patient with a measurement or reading, such as the patient's blood pressure, which in a hospital setting is not done by the conventional cuff, rather an LCD read unit wheeled into the room. Ancillary medical assistance is always required to help the patient at some given time, especially when a patient is being expected to do the therapeutic procedures that the medical apparatus they are using requires. It may only be to start the patient out, which takes guidance or it may be to oversee the patient with the task of assisting, guiding or prompting but, whatever the medical needs concerning the medical apparatus that is being used, ancillary medical assistance has in the past been a costly and time consuming requirement in order for medical apparatus to be used properly.

### SUMMARY OF THE INVENTION

The present invention relates to an improvement of medical apparatuses used by the medical industry by employing the use of audible, verbal, simulated human sounding voice or voices, produced with the appropriate electronic technology in correlation and synthesis with said medical apparatus to allow the operation of the apparatus to perform it's function by the process in which a word, words, or phrases, encourages, prompts, commands or guides the usage of the medical apparatus itself. For purposes of the present invention medical apparatus shall be considered those apparatuses that require ancillary medical assistance as a normal procedure when working with the patient (i.e. the medical apparatus needs partial or constant ancillary medical assistance to be appropriately utilized by the patient or as designated by the therapeutic guidelines set for the medical apparatus).Thus, the word medical, as herein specified, relates to those apparatus used in the Medical Field, Dentistry, Chiropractic, Therapeutic, Physical Therapy, and encompasses any therapy which requires ancillary medical assistance to properly guide for said medical apparatus to be used properly in order or to help benefit in the proper operation or measurements or regime required by the medical apparatus being use, to help the health or medical condition of the patient though said therapy.

Through the elimination of ancillary medical assistance by the use of the method of the present invention the patient can virtually use their prescribed medical apparatus on their own. The word patient, as herein specified, relates to any person or persons utilizing the above said apparatus in which ancillary medical assistance would be required to assist, therapeutically guide or prompt the patient's usage of the medical apparatus. The word humanlike relates to audible, verbal, sound which encompasses the likeness of the human voice and the characteristics thereof in order to replace ancillary medical help in order to help the patient and the medical industry. The purpose of the present invention, is to give incentive, prompt, encourage, or inspire the patient to use the above mentioned medical apparatus along with the function of the present invention to replace the required ancillary help necessary to guide the patient through the employment of an audible, verbal, simulated human sounding voice or phrases, as relates to the specification as herein described, so that the medical apparatus will do the same function that a human assistance would do.

The word ancillary medical assistance relates to a person or persons that have a normally required responsibility in relationship to the use of the medical apparatus for guidelines to the patient, other than the patient, herein specified. In order to accurately allow the concept of the present invention to encompass any combination of components necessary to facilitate the appropriate function, the exactness of structure of the components relating to the present invention will be the primary specification, as herein described. With the understanding that the embodiment to the present invention is confined to the usage of those components needed to facilitate the function of those apparatuses related to the medical field that can benefit from the use of an audible, verbal, simulated humanlike voice in order to eliminate ancillary assistance. The present invention encompasses the use of humanlike voices, producing a single word, words, or phrases, simulated, prerecorded, or artificially produced, as well as generated, or any similar process that can produce or supply the necessary function to facilitate the use of the present invention, however, the function of components will be given in exactness hereto.

The present invention could utilize beeps, tones, artificial sounds or noises, or anything similar that does not provide a humanlike sound of verbal simulated vocalization, but the preferred method for the function of the present invention is the use of simulated human sounding word, words, or phrases, as herein described and shall be specified as such. The word humanlike also encompasses the use of audible verbal words or phrases, or a single word that may sound different in a variety of tones, such as a speaking animal simulated voice, as animals do not normally speak, so the variation would be confined to audible verbal simulation of words according to the usage that sound like human words, encompassing any language in relationship to the medical apparatuses that pertains to the present inventions as herein described. The present invention also encompasses any and all future developed components in relationship to function and concept, that will accommodate the purpose of the specifications herein and provide the same concept pertaining to the medical field, as herein mentioned.

Since most medical devices only give incentive to the patient through visual confirmation, the present invention gives an added benefit through providing audible, verbal word, words, or phrases making the present invention not only valuable to the sighted, but a important benefit for the blind, as audible encouragement is the function being provided by the method as herein stipulated when the present invention is attached to, combined with, or related to a medical apparatus procedure in correlation with the function as a means for providing audible encouragement and/or audible required procedure times for, the above said medical apparatus, which is in synthesis with any and all of the parts, components, or equipment needed to provide the function of the new invention as herein mentioned.

Some examples of devices that normally require ancillary medical assistance that could benefit through the use of audible, verbal incentive, as described herein, but not limited to, are: Adhesively attached devices, utilized solely for patients requiring assistance for continual monitoring of temperature, or Telemetry devices that relate to, but not limited to, V-tach, V-fib, SVT, Brady arrhythmia's, that will allow the medical personnel to know audibly and verbal when rapid or slow heart rate occurs without being near the patient or medical device, Peak flow devices used for measuring lung capacity, Ventilators, which will allow patient's to know audible and verbally therapeutic requirements without being directly near the present invention or having to visually see the measurements, when critical parameters are causing complications and need to be met accordingly, normally overseen by an ancillary medical assistant. Heart rate monitoring devices for therapy in which ancillary assistance is necessary to measure or monitor to read or watch continuously by ancillary medical assistance for critical measurements relating to the patient, Oxygen tank informative devices, that can give an audible verbal verification of the amount of gas contained, whether full or empty allowing warning the doctor or medical personnel that the tank is now at a critical level without having to have an ancillary assistant to visually be confined to watching the levels, such as in an ambulance in which oxygen is administered and an ancillary medical assistant must keep the tanks filled as properly required to the exact amounts preventing deceased oxygen levels during travel, due to lack compliance by ancillary medical assistance to check the amount of oxygen during the trip to the hospital or other medical facilities, Voice timers in relationship to the medical profession, such as devices that will inform the doctor without the need for ancillary medical assistance of the time for a specific function, such as rinsing the heart valve, which should be rinsed for at least a specific amount of time due to the exactness required by an ancillary medical assistance to time the rinsing intervals for the doctor and by replacing this ancillary medical assistant with the audible, verbal use of the present invention, those doctors and professions will be informed of those exact times according to the particular field of medical work being done without human assistance, but not limited to the exact example as stipulated above, as there are many needs for timing procedures in which ancillary medical assistance required in relationship to a medical apparatus and providing timing for the function of that apparatus, so the above said usage of the present invention applies to the concept of a timing mechanism facilitating the necessary function normally required by ancillary medical assistance such as Incentive Spirometry Devices or Peak Flow Devices, normally used for lung rehabilitation. Blood pressure machines, which require ancillary medical assistance, as demonstrated in hospitals throughout the world, as well as, Pulse monitoring devices which only use visual incentive, such as LCD display to provide verification of adequate measurements, and with the use of the present invention no person or patient would be required to visually watch critical measurements or medical functions.

Since there are so many medical apparatus that require ancillary medical assistance to be used, the present invention is to be more inclusive of the function, as herein stipulated. The present invention encompasses those medical apparatus's that require ancillary medical assistance during the use of said medical apparatus in order to be adequately used by the patient or Medical Doctors and shall be confined to the fact that an ancillary medical assistance has been required to assist in the use of said medical apparatus at sometime during a related medical situation, even if the medical device could be used without assistance, though preferable not recommended. The aforementioned audible, verbal commands or responses produced by the present invention will allow the patient to obtain the particular goals, utilizing the present invention if needed to facilitate the function of the medical apparatus that it is being used with, herein described and can be adjusted accordingly to tell the patient the exact volumes, points, ratios, or performances and any other verification of operation necessary to supply the appropriate function required by that apparatus being used at the time, according to the pre-programming and shall be possible according to the function of the present invention as deemed necessary by the manufacturer, preferably as requested by the therapist or doctors according to the required therapy for the particular medical apparatus being used.

This availability to audibly and verbally hear the accurate readings and encouraging phrases to prompt usage by the patient will help the patient reach whatever goals or therapeutic pronunciation of exactness towards those goals, that the present invention provides, as herein specified, however, it is not required to allow the patient to set any adjustment and the preferred method of function of the present invention may be to not allow the patient to have any control over the medical apparatus that is being used in relationship to the function of the present invention rather only allow the patient to follow the directions provided as herein mentioned by the present invention. Since utilizing the combination of the present invention with the already existing above said medical apparatuses provides both visual and audible incentive, it is obvious that the combination of both audible and visual, is more applicable for fulfilling the most functional purpose, and will be described herein pertaining to such for those apparatus that require the combination within the housing of or attachment to the housing of the medical apparatus employing the present invention.

Thus the main purpose for the audible, verbal human voice commands or responses as provided by the present invention is to prompt usage of the above said apparatuses in order to improve whatever condition is being treated. There may be different technical ways of providing the simulated vocalization of a human sounding voice, but a method of technology necessary to produce the function as described herein, will show the utilization of the appropriate required combination of equipment necessary to produce the present invention in a unique and new method, thus this new method will not only fulfill the need to replace ancillary assistance in the medical field but it will also show how to also produce the best quality, audible, and verbally produced word, words, or phrases when attached to or combined with, the above said medical apparatuses and the following components in order to accommodate the patient's need for the sound of the voice being simulated, therapeutically guiding the patient accordingly. With the use of the “functional program” which can be used in all alternative embodiments to supply the appropriate function for each particular apparatus employing the present invention, in correlation with the timing mechanism which allows recognition of the daily required therapeutic predetermined therapeutic times and intervals which have been completed by the patient, according to the particular apparatus being used. The functional program will at a predetermined time engage the operation of each device in order to guarantee each operation been performed by the patient as well as, turn off and on the medical apparatus at said predetermined times to allow proper fulfillment of said therapy in which verbal guidance is being employed. This functional program can also extend the period mode for said intervals to a period as long as a night or day, according to the particular apparatus employing the present invention, in order to allow a sleep period when the apparatus is not being used and re-turn on as necessary to continue the compliance and procedures necessary for the term of the therapy required for each medical apparatus as applies until the complete process of therapy has been achieved.

One example, set for the components as described herein so that they will coincide with the visual readings that normally exist on those said apparatuses which will pertain to the patient's particular needs, with corresponding audible, verbal, simulated humanlike voice phrases, allowing the blind to benefit as well as the patient with sight, as the blind will be able to hear their settings, produced outputs, volumes, or ratios or any similar readings necessary to achieve the functions required, as well as any numeral context, but not limited to, relating to their input or preprogrammed function of the present invention. This is achieved by the target measurement gauged by the present invention as programmed in synthesis with whatever apparatus is being used in which a gauge or similar device is used to show measurement. When one reaches his or her particular goals, or completed the function of that apparatus utilizing the present invention, an audible verbal response in the unit will give an immediate indication of whether their perspective goals have been reached, through audible, verbal, simulated humanlike voices, giving the exact measurements and helpful incentive to encourage the patient to try harder or verbally confirm that the patient has achieved their goal accordingly.

A voice chip, or similar unit, but not limited to, as herein mentioned, constructed within the above mentioned new present invention, in combination with whatever apparatus is being used can provide simulated vocalization of human voices, (male or female, but not limited to), and will prompt or inform the patient through encouraging audible word, words, or phrases to either, “stop”, “try again”, or “good job you hit your mark” or “keep on going”, or similar phrase, or whatever phrase meets the particular specifications of the apparatuses being used, but not limited to, according to the particular use of the new medical device needed at the time. Should cost be a consideration, the present invention can be changed according to the number of commands, or responses and can be made complex or simple, giving the apparatuses more voices or phrases, or specific audible, verbal simulated vocalizations producing whatever amount of responses or commands that the construction of the apparatus needs according to it's usage, giving the apparatus the maximum optional ability, or the present invention can be constructed utilizing the minimal amount of parts, components, or equipment, as desired, to perform the necessary function of the apparatus being constructed.

Since, the usual voice modules, chips, microcontrollers, or similar devices or components, as aforementioned, provide the necessary function required as herein described, vary in price according to their capabilities, one can construct a more complex apparatus utilizing the present invention or modify the construction to meet the needs of the patient, or combined with the above said apparatuses at whatever degree of complexity is required to supply the necessary function. These audible, verbal, humanlike voice phrases comprised of commands and/or responses will give a corrective command if necessary, prompting the patient or person using the present invention to continue to use the apparatus in order to achieve the goals that have been set, or will prompt the patient to start using the device by constantly prompting usage, until the patient begins to use the present invention again.

A speaker, or similar device, can be attached to whatever housing as a part of the combination needed to produce the audible, verbal sound of the present invention on the aforementioned apparatuses as needed, as herein described and the present invention can have as many audible, verbal commands and responses as desired within the construction of the apparatuses supplying simulated humanlike voice, phrases or words as desired, according to the output potential employed by the construction of the above said apparatus, but not contained to any degree, yet confined to what technology currently provides, as specific ratios and output will depend on the application to promote the usage of each apparatus using the present invention as each apparatus may require particular specialization's to provide the audible, verbal, simulated humanlike voice phrases, word, or words, as the provider of the apparatus shall maintain the specifications or structure of each unit produced, in which the present invention is utilized.

Another important benefit of the present invention is the ability to install a programmable timer for letting the person manipulating the device, should this particular function be desired, not required, to recognize what time he or she should begin using the apparatus, in relationship to the above said purpose, function and concept as specified herein. A storing mechanism which can through digital technology or any other technology available, allow data to be stored, recording information relating to the patient's usage of the above said apparatuses, however not required, will allow the doctors or therapists to monitor the frequency of use and allow feedback to be given to the patient to help in their recovery, according to the medical diagnosis, utilizing the present invention as an instrument for monitoring the patients particular needs, to determine whether those patients not meeting their targeted goals should be given additional or more intensive treatment. Many times this is a hidden and unrecognized problem and monitoring can easily be recorded through the use of technology along with the present invention, however not required in relationship to the main function as herein described, allowing immediate feedback and monitoring of quality care, this can reduce complications, and can be provided without the use of medical assistance, according to the particular apparatuses being used.

It is commonly known to one skilled in the medical profession that one must be diligent to use the medical apparatuses prescribed, in order to benefit from the treatments and through the use of the present invention, which provides audible, verbal, simulated humanlike voices phrases and reminders that will continue to prompt the patient, giving audible, verbal encouragement, until the patient uses the apparatus again, in order to benefit the patient accordingly in relationship to the particular requirements of the medical apparatuses. Most physicians suggest usage of medical devices, usually on specific intervals, and the present invention can be set, or gauged according to the constructors desire, to provide audible, verbal, simulated humanlike voice phrases, to inform the patient of the exact times and intervals in which the patient should use their particular apparatus and only relates to whatever apparatuses that are employing said usage as herein described, that can benefit the patient by said usage as aforementioned, in relationship to the concept.

To expedite said usage at the prescribed times, the present invention will not only benefit the Medical Industry by supplying an audible, verbal, simulated humanlike voice, which will prompt, encourage, and inform the patient, or person using their particular medical apparatus, but it will also help decrease the recuperation time of the patient, by continually reminding the patient until the performed requirements required by that apparatus being used are met. Another, important function of the present invention through the technology available is to provide a way to retrieve data form the medical apparatus's which can be stored or recorded for viewing at a later time to provide the necessary monitoring and diagnosis according to those particular reading retrieved, however this is not required for the completion of the concept, rather an added advantage.

Another, added advantage, to the present invention is the ability to retrieve data from the medical apparatus from a base station through radio frequencies, or whatever technology allows such performance, such as a palm pilot or CP, that provide information without the doctor having to be present at the location of the patient or user. This function provided by the present invention confirms a well known principle valued by the medical profession that, “the more one uses the prescribed treatment, the faster one recuperates.” With the conception of the present invention a new step in medical progress will be made, as the patient will be using the device on their own, through the use of the present invention thus replacing the need for ancillary medical personnel, decreasing cost. Thus, this cost effective new device as well as a health benefit for the patient, disposable accordingly due to the extremely low cost for producing the new invention, or permanent according to the manufacturers desire will not only help the patient fulfill their goals for his or her medical progress as needed, but also save the hospital, a considerable amount of money, as the present invention will eliminate the need for supervised attention by ancillary medical assistance, replacing those present positions and responsibilities, by giving incentive to the patient, or gauging the patient's performance through the function of the present invention as specified herein, capable of performing mathematical and logical calculations” and decision logics which together constitute the “functional program”, which is normally a mandatory task perform by an ancillary medical assistant, all which will be accomplished by the employment of audible, verbal, simulated humanlike voices applied to, housed within, attached to, or separate in synthesis with those medical apparatus requiring such, for encouragement and guidance from the medical apparatus itself to prompt and increase patient's usage through the employment of human sounding words emulating in synthesis with the medical apparatus or it's general area of location, for the purpose of eliminating ancillary medical assistance.

### BRIEF DESCRIPTION OF THE DRAWINGS

FIG. 1 illustrates a perspective view of a preferred embodiment in accordance with the present invention within a separate housing from a medical apparatus;

FIG. 2 illustrates a block diagram schematic of the preferred embodiment;

FIG. 3 illustrates an alternative embodiment of present invention shown within the housing of the medical apparatus;

FIG. 4 illustrates a block diagram schematic of the alternative embodiment of FIG. 3; and

FIG. 5 illustrates a further embodiment of the present invention.

### BRIEF DESCRIPTION OF THE DRAWINGS

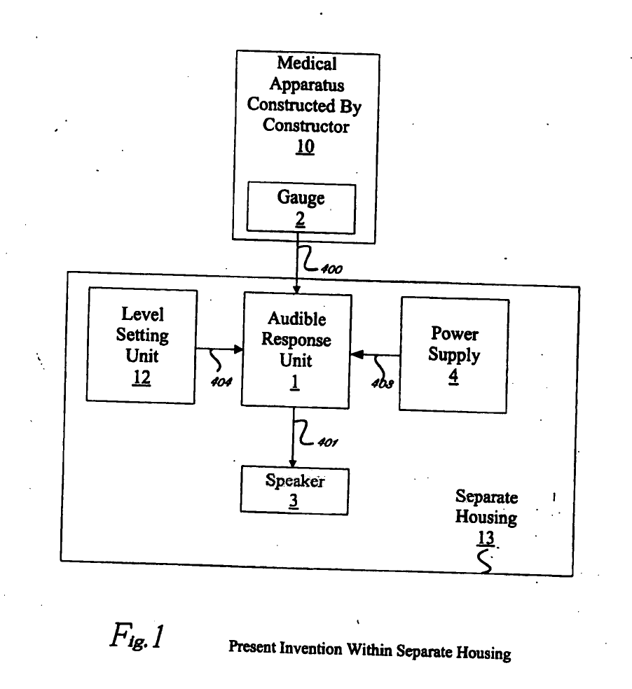

FIG. 1 Shows Preferred Embodiment of Present Invention. The present invention is enclosed within a separate housing 13 that does not include the Medical Apparatus Constructed by Constructor 10 and is comprised of Level Setting Unit 12, Audible Response Unit 1, Power Supply 4, and Speaker 3. A Gauge 2 within the Medical Apparatus Constructed By Constructor 10 connects to Audible Response Unit1 through one or more electrical connections labeled 400. A Level Setting Unit 12 connects to the Audible Response Unit 1 through one or more electrical connections labeled 404. Audible Response Unit connects to Speaker 3 through an electrical connection labeled 401. Power is supplied from Power Supply 4 to Audible Response Unit 1 through an electrical connection labeled 403.

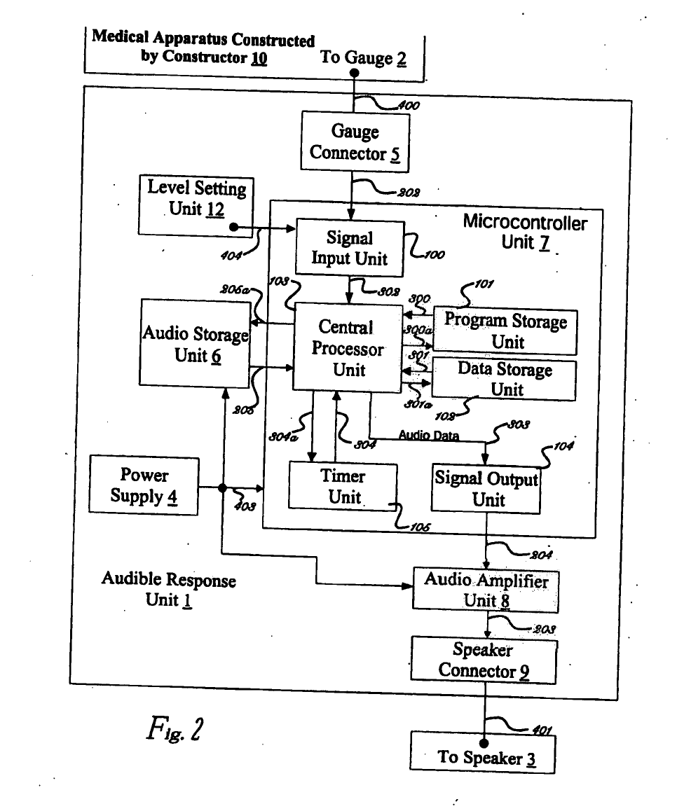

FIG. 2 shows the details of the Preferred Embodiment of Audible Response Unit 1 of FIG. 1 in relation to Medical Apparatus 10 and Speaker 3. Gauge 2 of Medical Apparatus 10 connects to Gauge Connector 5 through one or more electrical connections labeled 400. Gauge Connector 5 connects to Signal Input Unit 100 which is a subunit of the Microcontroller Unit 7 through one ore more electrical connections labeled 202. Microcontroller Unit 7 contains subunits Signal Input Unit 100, Program Storage Unit 101, Data Storage Unit 102, Central Processor Unit 103, Signal Output Unit 104 and Timer Unit 105.

Signal Input Unit 100 provides information to Central Processor Unit 103 through a set of signals labeled 302. Central Processor Unit 103 receives a set of program instructions that provide the function of the Audible Response Unit 1 from Program Storage Unit 101 by providing control information through signals labeled 300a and receiving instructions through signals labeled 300. Information used by the program instructions are kept in Data Storage Unit 102 by providing control information and data to be stored through a set of signals labeled 301a and by receiving data through a set of signals labeled 301. Central Processor Unit 103 controls a set of timers in Timer Unit 105 through a set of signals labeled 304a and receives information from the timers in Timer Unit 105 through a set of signals labeled 304. The Central Processor Unit 103 uses information from Timer Unit 105 to determine accurate time intervals.

Central Processor Unit 103 receives audio data from Audio Storage Unit 6 by providing control information through a set of signals labeled 205a and by receiving audio data through a set of signals labeled 205. Central Processor Unit 103 relays the audio data recieved from Audio Storage Unit 6 to Signal Output Unit 104 by transferring the audio data through a set of signals labeled 303. Signal Output Unit 104 transfers audio data to Audio Amplifier Unit 8 through a set of signals labeled 204.

Audio Amplifier Unit 8 transfers amplified audio data to Speaker Connector 9 through a set of signals labeled 203. Speaker Connector 9 connects to Speaker 3 through a set of signals labeled 401. Level Setting Unit 12 connects to Signal Input Unit 100 through a set of signals labeled 404. Power Supply 4 connects to Microcontroller Unit 7, Audio Storage Unit 6, and Audio Amplifier Unit 8.

When Medical Apparatus 10 in FIG. 1 is used by the operator, a Gauge 2 within the Medical Apparatus 10 produces an electrical signal on electrical conductor 400 proportional to the physical parameter that is measured by the Gauge 2. The electrical signal on 400 is variable over time and represents an electrical representation of the parameter measured by the Gauge 2 during the duration of time that the Apparatus 10 is used. The electrical signal on 400 is input to the Audible Response Unit 1 where the electrical signal on 400 is evaluated.

Referring to FIG. 2, the Gauge Connector˜relays the electrical signal on 400 to the Signal Input Unit 100 within Microcontroller Unit 7 where the electrical signal on 400 is converted repeatedly at a fixed rate of once every unit of time called the “sampling interval” for the duration of time when the electrical signal on 400 is being evaluated. The Signal Input Unit 100 converts the electrical signal on 400 into a digital numerical format and relays it through a set of digital electrical signals 302 to the Central Processor Unit 302. This process is repeated after the transpiring of time equal to the sampling interval for the duration of time over which the electrical signal on 400 is being evaluated.

The parameter being measured by Gauge 2 is thereby converted to a sequence of numerical digital values that represent the magnitude of the parameter over the time duration when the parameter is being evaluated, and each successive numerical digital value represents the magnitude of the parameter measured by Gauge 2 at the time that is one “sampling time” interval later than the preceding numerical digital value.

The Level Setting Unit 12 relays the electrical signal on 404 to the Signal Input Unit 100. This signal provides an indication of a setting that the operator wants to establish to the Apparatus in order to control or modify the behavior of the Apparatus. This setting called the “level setting” may take the form of a level of performance (goal) that the operator is indicating to the Apparatus. The Apparatus can decipher this setting and utilize it during the processing of Gauge information during the normal course of performing the function of the apparatus.

The Central Processor Unit 103 executes a sequence of instructions that are retrieved from the Program Storage Unit 10 I. This sequence of instructions is called the “functional program” and defines the series of steps and decisions that are made to constitute the function of the present invention. The Central Processor Unit 103 retrieves the instructions from the Program Storage Unit 10 I by presenting an index called a “program address” to the Program Storage Unit 101 through the set of digital electrical signals 300a. The “program address” is calculated by the Central Processor Unit 103 as directed by the instructions of the “functional program” that it is executing. The Program Storage Unit 101 responds to the “program address” on 300a by retrieving and relaying the instruction corresponding to the “program address” to the Central Processor Unit 103.

The instructions representing the “functional program” relayed to the Central Processor Unit 103 by the Program Storage Unit 101 over digital electrical signals 300a are executed by the hardware within the Central Processor Unit 103 to perform mathematical calculations, “program address” generation, and decision logic which together constitute the “functional program” of the present invention which in turn defines the behavior and function as defined for the Apparatus 10.

Intermediate mathematical and logical calculations that are performed by the Central Processor Unit 103 and compared to the “level setting” information as it executes the “functional program” result in information collectively called “data” that is stored in the Data Storage Unit 102. The Central Processor Unit 103 identifies storage locations in the Data Storage Unit 102 for storing or retrieving “data” by presenting an index called the “data address” to the Data Storage Unit 102 through a set of digital electrical signals 301a. The Central Processor Unit 103 generates the “data address” by performing calculations that it is directed to perform by the instruction of the “functional program” that is being executed. The Central Processor Unit 103 also presents “data” to be stored through the set of digital electrical signals 301a to the Data Storage Unit 102. If the Central Processor Unit is retrieving data from the Data Storage Unit 102, the Data Storage Unit 102 presents the retrieved data associated with the “data address” on 301a to the Central Processor Unit 103 through a set of digital electrical signals 301.

The Central Processor Unit 103 directs the Timer Unit 105 by presenting commands that are calculated during the execution of the “functional program” to the Timer Unit 105 through a set of digital electrical signals 304a. The commands instruct Timer Unit 105 on the time intervals that are to be generated. The Timer Unit 105 relays time interval information to the Central Processor Unit 103 through a set of digital electrical signals 304. The Central Processor Unit 103 uses the timer interval information for purposes of indicating when one or a set of instructions of the “functional program” should execute. This provides the ability of the Central Processor Unit 103 to synchronize the execution of one or a set of instructions of the “functional program” to a precise point in time or an interval of time.

When the Central Processor Unit 103 determines that an audible response is needed and which audible response is to be generated as determined by the definition of the behavior of the Apparatus 10 and the definition of the “functional program”, it is directed by the instructions within the “functional program” to calculate an index called the “audio address” that is used to retrieve the audible response data called “audio data” from the Audio Storage Unit 6. The Central Processor Unit 103 presents the “audio address” to the Audio Storage Unit 6 through a set of digital electrical signals 205a. The Audio Storage Unit 6 responds by relaying the “audio data” associated with the “audio address” to the Central Processor Unit 103 through a set of digital electrical signals 205.

The Central Processor Unit 103 retrieves time interval information from Timer Unit 105 to determine the appropriate time when retrieved “audio data” can be relayed to the Signal Output Unit 104. In this way, the “audio data” is successively relayed to the Signal Output Unit at a rate appropriate for the regeneration of the audible response from the “audio data”. The Central Processor Unit 103 relays the “audio data” to the Signal Output Unit 104 through a set of digital electrical signals 303.

The Signal Output Unit 104 receives “audio data” from the Central Processor Unit 103 at a rate that is indicated by time interval from the Timer Unit 105. The time interval is calculated by the Timer Unit 105 as it is commanded to do by the Central Processor Unit 103 when it executes the instructions in the “functional program” that controls setting up of the Timer Unit 105. The time interval is made to be the value required in order to regenerate the audible response correctly when “audio data” is repetitively output at a rate equal to the time interval.

The Signal Output Unit 104 receives “audio data” in a digital numerical form from the Central Processor Unit 103 repetitively starting from the first unit of “audio data” to the last unit of “audio data”. The Signal Output Unit 104 converts the “audio data” to an electrical signal whose magnitude is proportional to the “audio data” repetitively for each “audio data” received. It relays the electrical signal to the Audio Amplifier Unit 8 through an electrical signal 204. The Audio Amplifier Unit 8 multiplies the magnitude of the electrical signal relayed on the electrical signal 204 such that the amount of power represented by the electrical signal 204 is increased and output to the Speaker Connector 203. The Speaker Connector 9 relays the amplified electrical signal on 203 to electrical signal 401 which corresponds to electrical signal 401 on FIG. 1. The amplified electrical signal 401 is presented to the Speaker 3 in FIG. 1.

The Speaker 3 converts the amplified electrical signal 401 to sound energy that represents the audible response that the Audible Response Unit 1 has calculated in response to the measurement of a parameter that is determined by the Gauge 2 of the Medical Apparatus 10 in accordance to the defined behavior of the Apparatus and of the defined function of the “functional program.”

The present invention describes a method of producing audible response to the measurement of a parameter by a Medical Apparatus 10 so that the audible response is done according to a defined behavior determined by the constructor of the Apparatus. Implementation of the defined behavior of the audible response to measurement of a parameter within the Medical Apparatus 10 is realized by the defined function of the “functional program” that is coupled to the Audible Response Unit 1 by storing the “functional program” in the Program Storage Unit 101 within the Audible Response Unit 1 and by providing a means for the Central Processor Unit 103 within the Audible Response Unit 1 to execute the instructions in the “functional program” and to perform the actions as they direct the Central Processor Unit 103 and the other subunits within the Audible Response Unit 1.

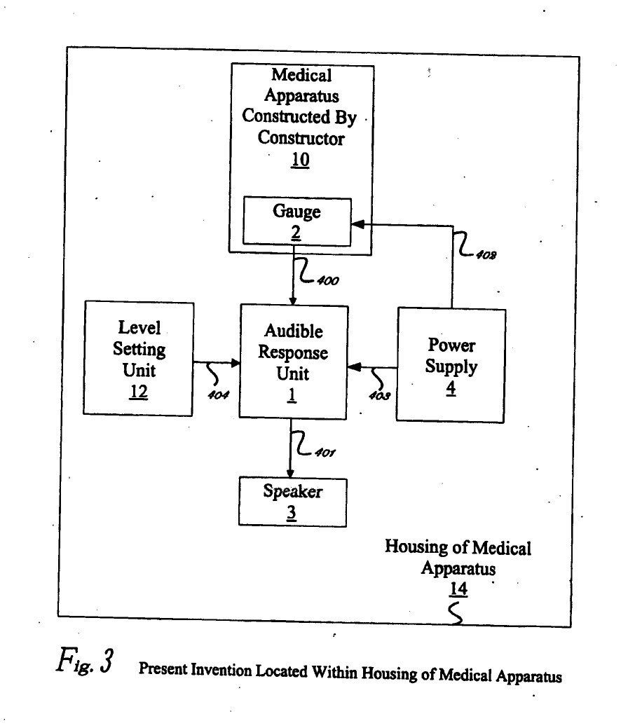

FIG. 3 Shows an Alternative Embodiment of Present Invention. In this Alternative Embodiment of Present Invention, the present invention and the Medical Apparatus Constructed By Constructor 10 are contained within the same Housing 14. The Power Supply 4 provides power to the Medical Apparatus 10 through one or more electrical connections labeled 402. The present invention is comprised of the Level Setting Unit 12, Audible Response Unit 1, Power Supply 4, and the Speaker 3. In all other respects, the Alternative Embodiment of Present Invention in FIG. 3 is the same as the Preferred Embodiment of Present Invention in FIG. 1.

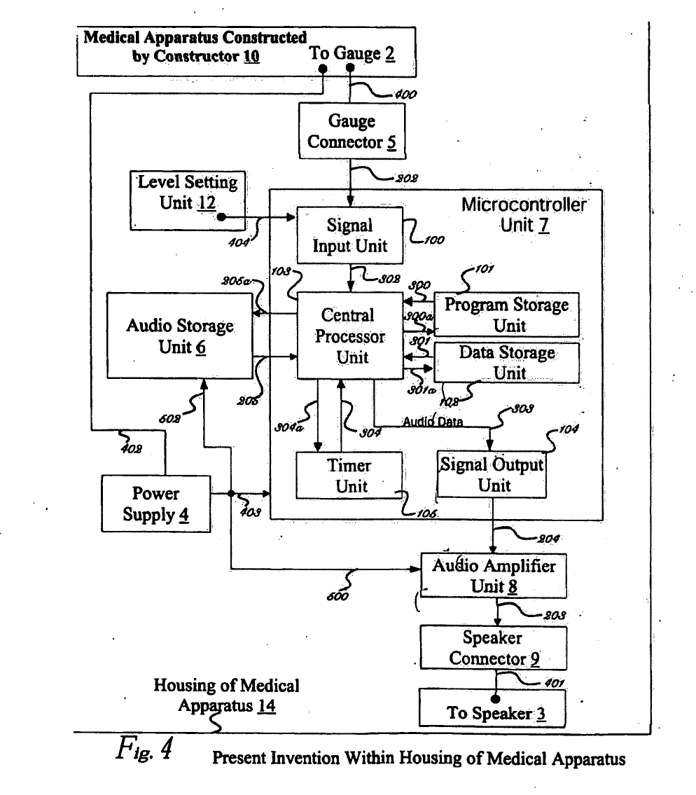

FIG. 4 shows the details of the Alternative Embodiment of Audible Response Unit 1 of FIG. 3 in relation to Medical Apparatus 10 and Speaker 3. In FIG. 4, the Power Supply 4 connects to Microcontroller Unit 7, Audio Storage Unit 6, and Audio Amplifier Unit 8 through a set of electrical connections labeled 403. The Power Supply 4 also connects to the Gauge 2 within the Medical Apparatus 10 through a set of electrical connections labeled 402. In all other respects, the Alternative Embodiment of Audible Response Unit 1 of FIG. 4 is the same as the Preferred Embodiment of Audible Response Unit 1 in FIG. 2. In all other respects, description of the operation of the Alternative Embodiment of Present Invention in FIG. 3 is the same as the description of operation of the Preferred Embodiment of Present Invention in FIG. 1.

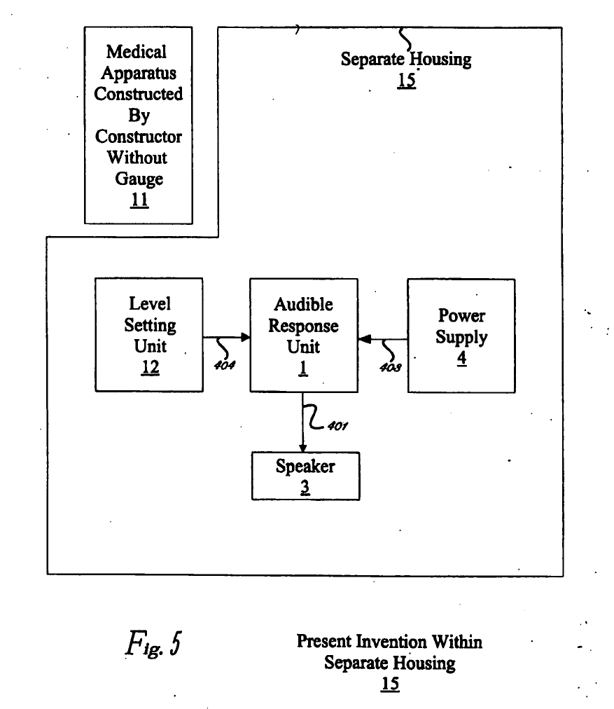

FIG. 5 Shows an Alternative Embodiment of Present Invention. Referring to FIG. 5, this Alternative Embodiment of Present Invention shows the Audible Response Unit 1 connected as it is in FIG. 1 except with no connection to a Gauge within Medical Apparatus 11. In this embodiment, there is no gauge that provides information to the Audible Response Unit 1. The Medical Apparatus Constructed by Constructor without Gauge 11 in FIG. 3 may or may not have a gauge to measure some parameter of interest, but that gauge information is not provided to the Audible Response Unit 1. In this Alternative Embodiment, the Apparatus 11 is used in conjunction with the Audible Response Unit 1 in a way that the Audible Response Unit 1 provides therapeutic guidance audio information on Apparatus Operation to the operator of the Apparatus 11, therapeutic guidance audio information to cause the use of the Apparatus 11 according to a programmed schedule of time, and provides therapeutic guidance audio information so as to cause the repetitive use of the Apparatus 11 as required for proper use of the Apparatus. The Audible Response Unit 1 provides the therapeutic guidance audio information to the operator of the Apparatus 11 in order to eliminate the need for ancillary assistance, and in order to cause the proper use of the Apparatus 11 so as to provide maximum benefit from its use.

Some of the advantages and features of the present invention include, but are not limited to, the following:

I. a new method to provide assistance for utilizing medical apparatus in which the ancillary medical assistance does not have to directly be present to guide, prompt, or give measurements to the patient or medical personnel, as the invention shall, through electronic technology provide the necessary guidance to the patient as well as give audible information to medical personnel if needed and shall eliminate the need for ancillary medical assistance;

1) a method of eliminating ancillary medical assistance in relationship to medical apparatus that requires the presence of an ancillary assistance sometime during the medical apparatus's use by the patient;

2) replacing the normal human voice commands, responses, word, words, phrases or measurements that ancillary medical personnel normally provide to the patient, relating in relationship to medical apparatus with a human sounding electronically programmed voice or voices, giving the same basic therapeutic program requirements with adequate performance from the apparatus itself or within the range for providing the function of the medical apparatus being utilized, to prompt the patient to use the medical apparatus, as well as, guide the patient through the proper steps of using said medical apparatus, in order to fulfill the patient's therapeutic regiment that is required in order to encourage recovery;

3) replacing the normal human visual readings or measurements that are produced by medical apparatus and read by ancillary medical personnel to facilitate the function of the medical apparatus with a human sounding electronically programmed voice or voices giving the same readings or measurements as deemed necessary to provide the patient with adequate information to fulfill the patient's therapeutic regiment for recovery;

IL A new method to provide the above function of the present invention through the following electronic technology:

1) a number of the following electronic components in order to provide the function as listed in the above advantages:

(a) one or more electronic sensors producing an output signal,

(b) one or more electronic modules that convert said sensor output signal (s) into digital format,

(c) one or more electronic modules that includes but is not limited to a central processing unit,

(d) one or more electronic modules for digital storage of program instructions and data,

(e) one or more electronic modules for digital storage of digital audio sound data,

(f) one or more electronic modules for generation of audible sound,

(g) one or more electronic modules for managing and conserving electrical power,

(h) one or more electronic modules for determining accurate intervals of time

(i) one or more electronic modules for communicating remotely with separate agent

2) said method of new apparatus capable of measuring output signal of the sensors, converting said output signals into digital format to be stored and processed by the central processing unit, resulting in actions taken by the central processing unit under direction of it's digital program instructions in accordance to it's predetermined set of actions,

3) said pre-determined actions of the digital program instructions include but not limited to the generation of audible audio sound sequences that provide information relating to said output signals,

4) said electronic sensors capable of measuring but not limited to parameters of performance of the human body in various settings relating to medical therapeutic performance, or physical training,

4a) said electronic sensors being comprised of, but not limited to, a resistor that forms a variable resistance to electric current flow, such as a film of carbon, but not limited to, that forms a resistance to electric current flow, in contact with said resistor,

5) said central processing unit capable of performing tasks as specified in the order defined in digital program, including, but not limited to processing of sensor output signals, execution of control functions defined by the digital program, providing actions in accordance to accurate time intervals, generation of audible sound,

6) said digital program defines control functions that implement therapy or physical rehabilitation regimes,

7) said digital program defining control functions that implement tasks for managing and conserving electrical power,

8) said digital program defining control functions that implement tasks for determining accurate intervals of time,

9) said digital program defining control functions that implement tasks for determining time of day, (for those medical apparatus that need to be turned on or off to begin or end therapeutic sessions),

10) said digital program defining control functions that implement tasks for communicating with a separate agent,

11) said digital program being stored in memory within the electronic module that contains the central processing unit, and or being stored in memory that is not within the electronic module that contains the central processing unit but that is accessible by the central processing unit,

12) said digital audio sound data being stored in memory within the electronic module that contains the central processing unit, and or being stored in memory that is not within the electronic module that contains the central processing unit but that is accessible by the central processing unit,

13) directory table containing descriptive information about those commands, responses, measurements, or words as aforementioned about said digital audio sound data that is stored in memory within the electronic module that contains the central processing unit, or being stored in memory that is not within the same electronic module that contains the central processing unit but that is also accessible to the central processing unit,

13a) said digital audio sound data being arranged into multiple units, each unit representing an audible verbal message comprised of a series of words as programmed per the requirements in synthesis with the medical apparatus's therapeutic use,

13b) a method for retrieving and generating the audible sound representing the digital audio data from the start of the message to the end of the message as corresponds to the therapeutic dialogue needed,

13c) a method for retrieving and generating the audible sound representing the digital audio data from an intermediate point in the message to a subsequent intermediate point in the same message, to allow the medical apparatus to respond to the measurements being produced by the patient accordingly and guide the patient according to the measurement amount,

14) said electronic module for generation of audible sound being the same electronic module that contains the central processing unit, and or a being separate electronic module for the module that contains the processing unit,

15) said electronic module for generation of audible sound including a module that converts digital audio data into continuous analog signal that is amplified to increase the signal power as needed to create audible sound from sound generating modules such as, but not limited to, speakers,

15a) said electronic modules for generation of audible sound providing a sound generating a continuous analog signal that is one half the value of the maximum signal level, such level representing zero sound to be generated,

15b) said electronic module for generation of audible sound providing a sound generating module such, but not limited to, speaker(s) that is capable of receiving a level that is one half the maximum signal level in a way that produces no sound and consumes little or no power,

15c) said sound generating module such as, but not limited to, a speaker(s) whose reference signal level is set at one half the maximum signal level such that it produces no sound when it receives such a signal level,

15d) said sound generating module being provided a reference signal level set at on half the maximum signal level by connecting it between a series of batteries in a way that provides a reference signal that is exactly on half the signal level that is produced by the above said batteries connected in this way,

16) said digital program defining a method for determining the value of a sensor output signal, generating an audible verbal response according to a predetermined set of controls and functions as described herein, in order to provide therapeutic guidance information to the operator of whatever medical apparatus is being used for guidance which is being generated for the purpose of eliminating the need for ancillary medical assistance and improving the operators use of the medical apparatus as herein specified.

17) said digital program defining a set of predetermined set of controls and functions relating sensor output signals to audible verbal commands, responses and measurements, comprises of improving medical conditions of the patient through the use of the said medical apparatus accordingly, along with the present invention.

The function of the present invention is the ability to produce audible, verbal, humanlike voices, commands and/or responses that helps a patient or person using a medical apparatus or device, to easily comply with the particular usage that the apparatus or device requires. The invention is not limited to any particular medical apparatus or device.

In order to have a way of defining the guidelines for the apparatuses and devices, one can consult guidelines established by the United States Government, as a basis for each apparatus and/or device and what it's particular requirements are, per these guidelines. One non-limiting set of guidelines for certain apparatuses and/or devices that can be used with the present invention is the American Association of Respiratory Care (AARC) www.aarcbuyersguide, which is incorporated by reference. Since it would be impossible to list every apparatus and/or device that is encompassed in relationship to the present invention one can go to the AARC buyers guide on the Internet and look at the non-limiting list of apparatus and devices that are presently available and would benefit from the technology encompassed within the function of the present invention.

Other non-limiting examples, which are also incorporated by reference include, other medical organizations, such as, but not limited to, the American Hospital Association medical apparatus lists, the American Cardiothoracic Association's list, the American Heart Association's Medical Device lists, etc. or any Governmental organization that specifies devices or apparatuses. Again these lists are not inclusive to the function or use of the present invention as t can be up to the professional to appropriately use the claimed function of the present invention as seen or needed. For example as mentioned above, a cane or chair could even be used to attach a verbal notification of the time to take a step or medication. The above organizations and associations are not considered the sole references for identifying devices and apparatuses that can be used with and benefited by the present invention. The function of the present invention is it ability to be utilized in limitless amount of ways which may include apparatuses and devices not referenced in any particular list. The above organizations and associations are helpful for providing an aid to allow the present invention to be programmed or otherwise conform to guidelines established for medical apparatuses and devices associated with these organizations and associations.

Thus, where guidelines, regulations, requirements, etc. have been established by one or more organizations, associations, governmental bodies, referring to such guidelines, etc. when using the present invention with the apparatus or device can be beneficial. However, given the limitless ways that the present invention can be beneficially used, other apparatuses and devices not referenced and/or other ways and methods for referenced apparatuses, may also be found to capable and/or appropriately used with the present invention system and all of these apparatuses and devices and other ways of use for referenced devices are also considered within the scope of the invention. Accordingly, a physician or other person may find ways to use the present invention with an object, apparatus, device, etc. that medically benefits a patient or person and such other ways are also considered within the scope of the invention.

Thus, as non-limiting examples, from a cane that simply, verbally encourages the patient, or person, to walk another step to Intermittent Positive Pressure Breathing (IPPB), mechanical administered, the technology encompassed within the function of the present invention can be used. For instance; using the present invention in connection with IPPB, the audible, verbal, ability of the system provided by present invention will speak to the patient that it is going to provide the ventilation used for the purpose for augmenting lung expansion, by pre-programmed electronic words that could say; “It is time for another lung expansion” or other similar expressions or messages. This will provide a unique and beneficial quality to the mechanism, thus, allowing the patient or person, using the IPPB machine to know when the next session is going to happen, thus, taking some of the stress away from this delicate procedure. Each of the medical apparatus named on the AARC buyers guide has a relationship that can be benefited by the function of the present invention, and which benefits to implement using the present invention technology.

Any person would rather hear a voice that they can understand explaining a procedure, than be provided with only a written information sheet or a small period of time that a nurse can give to the patient or person, due to the lack of ancillary medical help.

From Blood Pressure devices that only show the LCD read out to Chest Physiotherapy Devices, the present system represented by the specification and claims of the present invention, show a more friendly and useful way of providing assistance and information that any human being would appreciate (e.g. would not a person rather hear the readings of their blood pressure, than to have to look at a visual readout on a piece of paper or and LCD panel. Even a chair (i.e. retirement home, hospital etc.) can be provided with the present invention technology to provide encouraging words or messages, such as, “time to take your medicine”, etc.

Given the unlimited uses of the present invention, it becomes apparent that one cannot restrict the application of the present invention to only a few medical apparatuses or devices, as all medical apparatuses and devices can benefit from the use of the present invention.

As discussed above and throughout the specification, the present invention can be used with all medical apparatuses and devices and is not considered limiting to any particular apparatuses or devices. With such understanding, various non-limiting examples of medical apparatuses and devices that are claimed as part of the function of the technology in relationship of the present invention can include the following:

Airway Devices—(as described above in the specification under ventilators and devices that are used to measure lung capacity or relate to the lungs).

Endotracheal Tube Attachment Devices—such as verbally instructing with the present invention the procedure for attaching properly. One of the medical apparatuses used in relationship to Peak flow therapy under spirometry and the lung function.

Esophageal Obturator (EQA)—used in cardiopulmonary resusicatative procedure by inserting the EQA into the patients lungs and thus would be consider in the catagories described above in the specification under Heart Monitoring devices, or spirometry therapy. One non-limiting function of the present invention in connection with the EQA could be providing verbal instructions on usage.

Laroyngoscopes—used to examine the patient's lungs and a suction device for removing mucus which can be considered under the above identified categories of lung apparatus, ventilators, spirometry etc. Again, one non-limiting function of the present invention would be to provide instructions on usage. It is also important to again note that there are many other airway devices and apparatuses that fall under the same representation and functional usage that can be benefit and be used with the present invention and all are considered within the scope of the invention.

Analyzers—apparatuses and/or devices used to dispense and/or analyze different gases when used with the present invention could verbally provide the names, amounts or necessary procedure or instructions to provide the guidelines per gas as necessary for the patient, in relationship to the following: (i) Blood gases (pH, PCO2, PO2) (ii) Calibration—function is verbal instructing the necessary calibration per the guidelines and the particular apparatus or device being used, or show what gases need to be added or deleted accordingly; (iii) Gases include, but are not limited to, the following: Carbon Dioxide, Carbon Monoxide, Electrochemical, Electrolye, Helium, Nitric Oxide, Nitrogen, Nitrogen Dioxide, Oxygen, etc.

Blood Gas Devices—same function as above and would be in synthesis with whatever device is being utilized in order to give a verbal acknowledgement of the gas involved.

As discussed above in the specification, the present invention can be attached to, or combined with a medical apparatus or device. The embodiments of the present invention can be in communication with those components of the apparatus or device needed to facilitate the function(s) of such apparatuses and devices related to the medical field that can benefit from the use of an audible, verbal, simulated humanlike voice in order to reduce or eliminate ancillary assistance. Further non-limiting examples include:

Blood Pressure Devices—as mentioned above the function of the present invention can provide a verbal reading instead of a visual or LCD reading, allowing the patient, (blind or otherwise), to hear their numbers in relationship to the particular patient's pressure.

Cardiac Diagnostics—relates to the function of the present invention as described above in the Specification to cover all Heart Monitoring needs, such as, but not limited to, V-Fib.

V-Fib—when monitoring the heart beat, sometimes a patient or person has a rapid heart beat called V-fib which can be dangerous as the heart rates can go over 140 beats per minute. This can lead to heart attack if not recognized immediately. One function of the present invention as described above in the specification, is to give an immediate audible, verbal warning and reading, as necessary to alert the necessary professionals in order to adequately provide the necessary medical procedures and/or drugs to reduce the heart rate. Another function of the present invention can also be used when the heart rate is too slow, which also is a dangerous situation.

Oxygen Tank—normally used to provide oxygen to a patient in the hospital to provide the greatest ability for the body to recover. In other situations, such as; Ambulance procedures the patient who is being rushed to the hospital is normally placed on oxygen, coming from the oxygen tank, however, many times the tanks have not been re-filled accordingly and run out of gas causing death and the ancillary assistant is not aware of the problem until it is too late. This can be avoided by the use of another function of the present invention, as the present invention can provide an audible, verbal, response and warning, as necessary that will state that the tank is low, thus, allowing the assistant to either change tanks or take the appropriate medical actions.

Ventilators—there are many different types of ventilators, one that is used quite often is for post-operative surgery patients that due to their use of a separate breathing machine, have their lungs collapse, (which is normal), during the procedure. But, after the operation, the patient must be on a ventilator that provides moisture to help the lungs heal accordingly on different intervals . . . usually every several hours during the day. Another function of the present invention can be to provide audible, verbal, instructions to the patient that it is time for the next inhalation of medicated gas for this particular procedure.

Breathing providing apparatus—As mentioned above, during surgery a machine is often used to breath for the patient, such as while under anesthesia so that the patient can be operated on appropriately per the standards set forth. However, should the machine stop working, the function of the present invention will automatically, audibly and verbally announce that the machine is having problems or has stopped, even if the physician has not noticed it, preventing death, or other serious situations for the patient. This use of the present invention can be included under the use of any/all medical apparatus that can benefit and can also be considered under the “critical parameters” that can occur in any medical situation, that would benefit from the present invention.

Lung Rehabilitation—here another function of the present invention is its use with several different medical apparatuses or devices, such as, but not limited to, the spirometer or Peak Flow meter. Again these are only non-limiting examples of a few. However, the function of the present invention in synthesis with whatever medical apparatus is being used to rehabilitate the lungs can be used to provide verbal promptings and instructions (preferably programmable) to help the patient's recovery and assure compliance.

Medical/Aerosol Delivery Devices and Apparatuses—used by patients on different time intervals and require certain supervision, which can be done by the patient as well as, an ancillary assistant. One benefit of function of the present invention would be to provide the patient or person using the delivery systems to have a verbal prompting of when to use them and how much or how many times. These devices and apparatuses can be included in the above description for ventilators and benefiting the patient through whatever apparatus or device is used. Some non-limiting examples include, but are not limited to, the following: Aerosol face tents, Aerosol Masks, Air compressors which force delivery, Flowmeters, IPPB, Medication Nebulizers, Metered dose inhalers (though metered the patient depending on age may not know exactly how to use the devices, thus, the present invention would instruct them verbally), etc.. Nebulizers examples include, but are not limited to, the following: Breath-actuated, Continuous (though continuous, the patient may need guidance and verbal encouragement to continue usage), Heated, prefilled, Pneumatic, Ultrasonic, etc.

Monitors which monitor one or more of the following non-limiting examples—Airway Pressure, Apnea Monitors/Recorders, Arterial Blood Gas, Blood Pressure, Carbon Dioxide, Carbon Monoxide, Cardiac, Hemodynamic, Holter, Hydrogen, Multiparameter, Nitric Oxide, Nitrogen, Nitrogen Dioxide, Telemetry (as mentioned above), Temperature (as mentioned above), Transcutaneous, Carbon dioxide/oxygen, Ventilator (as mentioned above). All of the above fall into one or more above-described specified fields and encompass the ability to use the function of verbally, prompting, indicating, or instructing the above said monitors.

Peak Flow Meters—Used to measure volume in the lung of gases and through the function of verbally, and audible instructing prompting and giving measurements fall under the methods encompassed by the present invention. Some areas of use for Peak Flow Meters and equipment, include, but are not limited to the following: Personal Protective Equipment, Face shields, Eyewear, etc.

Pulmonary Function Testing—These processes test the function of the lungs and are previously described above in the specification as a medical example in relatonship to lung health as any/all apparatus that can benefit from the present invention, through audible, verbal instructions, promptings and measurements.

Airway Resistance—Interrupter Devices (none verbal—LCD or paper readout), Oscillatory Devices, Plethsmogaphs (which are read not heard), etc.

Bronchoprovocation—Dosimeters that are set up manually for dose dispensing, which can be inaccurate if the patient does it incorrectly. Verbal, instructions through the present invention relating to the lung health would advocate a more advantagous benefit and help to correctly set up for use.

Spirometers—All relating to the lungs and measurements which through the present invention can allow the patient or person using to hear their measurement and be prompted on the way to use the apparatus. Types of Spirometer include, Diagnositic, Monitoring and Screening.

Pulse Oximetry—measures oxygen in blood. The present invention can verbally provide the measurement.

Sleep Diagnostics—all the different monitoring devices, such as the Audio/Visual would benefit from verbal audible instructions and peaceful comforting words, to help in the patient's therapy in order to benefit the apparatus's usage.

Suction Devices—all of which through the function of the present invention can be provided with audible, verbal words for instructing in the usage Heart monitoring devices and apparatuses, include, but are not limited to, Cardio Surgical Artial Filbirillition devices, Flutter Value (used for breaking up mucus in patient), Intra aortic balloon pump, Robotic surgery (can warn and instruct operator), EKG testing, Treadmills for heart monitoring. Additionally, all apparatuses and devices used or referred by the American Heart Association and the American Hospital Association. All of these apparatuses and devices can be benefit with use of the present invention to benefit the patient or technician by providing verbal instructions, readings and/or measurements.

All device needed or in correlation for anesthesiology apparatuses or machinery as specified as beneficial to the patient or technician by providing audible, verbal instruction, prompts, etc. as needed.

All of the above non-limiting examples can benefit from an audible, verbal instruction, guidance or prompting to help patient compliance, which are provided through use of the present invention.

What is claimed is:

1. An improved medical apparatus comprising:
a medical apparatus of a type that requires ancillary medical assistance to ensure, prompt, inspire, entice, command, respond, inform or encourage recommended or required therapeutic use by a patient using said medical apparatus or in correlation with any medical procedure working in synthesis with said medical apparatus;
an electronic assembly comprising a microcontroller unit controlled by a functional program and an audio storage unit, said audio storage unit having at least one stored audible verbal message for prompting, enticing, commanding, inspiring, responding, informing or the patient to use said medical apparatus or which provides therapeutic guidance to the patient regarding use of the medical apparatus; wherein the functional program controls the operation of said electronic assembly and eliminates the need for ancillary medical assistance when therapeutically guiding the patient to use said medical apparatus;
means for powering said electronic assembly; and
a speaker in communication with said electronic assembly for receiving said at least one stored audible verbal message from said audio storage unit upon direction from said microcontroller unit and transmitting the at least one stored audible verbal message directly to the patient to encourage compliance with the therapeutic guidelines for said medical apparatus by the patient without the necessity of having a live ancillary medical assistant present with the patient for such purposes.

2. The improved medical apparatus of claim 1 further including means for verbally indicating to the patient a measurement or result achieved by the patient from the performance of the required or recommended therapeutic procedure with said medical apparatus; wherein the measurement or result achieved is calculated through mathematical and logic calculations performed by the functional program.

3. The improved medical apparatus of claim 2 wherein said means for verbally indicating comprising:
means for receiving analog signals relating to the user's performance with the medical apparatus;
a level setting unit providing a performance level or goal for said medical apparatus; and
means for converting the receiving analog signals from said medical apparatus into digital data;
wherein a message sent from audio storage unit to the speaker by direction of the microcontroller is based on the analog signal received from said medical apparatus and the performance level or goal provided by the level setting unit.

4. The improved medical apparatus of claim 3 wherein said means for receiving is a gauge provided on said medical apparatus and a gauge connector in communication with the gauge and a signal input unit of said microcontroller unit; wherein said level setting unit in communication with said signal input unit.

5. The improved medical apparatus of claim 1 wherein said microcontroller unit directs the audio storage unit to send a first verbal message to the speaker in order to prompt use of said medical apparatus device by the user as needed in relationship to said medical apparatus.

6. The improved medical apparatus of claim 5 wherein in relationship to said medical apparatus being used for powering said electronic assembly, said electronic assembly having a timing device for determining when to automatically send said at least one stored verbal message from said audio storage unit to said speaker in order to prompt, remind, entice, inspire or encourage the patient to use said medical apparatus as needed in relationship to said medical function of said medical apparatus to perform the required procedure as therapeutically required or recommended for said medical apparatus.

7. The improved medical apparatus of claim 6 wherein said microcontroller unit is programmed to direct the audio storage unit of output signals at a set time to send a first verbal message to the speaker in order to prompt use of said medical apparatus device by the user from the audio response relayed from a Signal Output Unit of the electronic assembly at a rate appropriate for the regeneration of an audible response from the audio data.

8. The improved medical apparatus of claim 5 wherein said microcontroller unit continues to direct the audio storage unit to send the first verbal message or another verbal message to the speaker on a spaced apart continuous basis until said microcontroller unit learns that the user has begun to perform the required procedure with said medical apparatus.

9. The improved medical apparatus of claim 5 wherein after the required procedure has been performed by the user said microcontroller unit is programmed to wait for a predetermined therapeutic time period before directing said audio storage unit to send a next initial verbal prompting message to the user for prompting the user to perform another required procedure; wherein the user is encouraged to perform multiple required procedures with said medical apparatus device being employed during a single day period as therapeutically required or recommended for said medical apparatus.

10. The improved medical apparatus of claim 1 further comprising means for verbally indicating comprising:
means for determining a measurement or result achieved by the user from performing the required procedure with said medical apparatus;
an audio response unit;
means for powering said audio response unit; and
a speaker in communication with said audio response unit; and
wherein a signal corresponding to the measurement or result achieved by the user is sent by said means for determining to the audio response unit which generates a verbal message which is sent to the speaker to verbally indicate to the user the measurement or result determined and also sends a verbal functional message appropriate for the measurement or result determined according to a performance level or goal for the medical apparatus.

11. The improved medical apparatus of claim 10 wherein said electronic assembly further comprising a timer, controlled by a functional program of said microcontroller unit, for dictating when audio messages are sent to the speaker by said audio response unit; wherein the functional program controls a timing unit to allow the appropriate time for the therapeutic use of said medical apparatus according to said medical apparatus.

12. The improved medical apparatus of claim 11 wherein the verbal encouragement message sent is chosen from a plurality of verbal messages stored in said audio data message storage unit; wherein, in relationship to the functional program stored within the microcontroller unit that defines the behavior of said medical apparatus in accordance to a defined function, at least one of the plurality of verbal encouragement messages is used where the measurement or result determined is lower than the target measurement and at least one of the plurality of verbal encouragement messages is used where the measurement or result determined is higher than the target measurement; wherein the plurality of verbal messages allow an appropriate verbal message to be selected, according to the user's measurement or result performance of the required procedure according to said medical apparatus.

13. An improved medical apparatus comprising:
a medical apparatus having of a type that requires ancillary medical assistance to ensure or encourage recommended use of said medical apparatus by a patient; and
means for automatically verbally prompting the patient to use said medical apparatus to perform a medical procedure achieved through the use of said medical apparatus without having to have a live ancillary medical assistant physically present with the patient;
wherein said means for verbally prompting disposed within or attached to a housing of said medical apparatus or disposed within its own housing separate from said medical apparatus.

14. The improved medical apparatus of claim 13 wherein said means for verbally prompting is either disposed within or attached to said housing of said medical apparatus; and said improved medical apparatus further comprising means for verbally indicating and verbally responding accordingly to a patient based on a measurement or result achieved by the patient from the patient's performance of the required procedure, said means for verbally indicating and verbally responding disposed or attached to a same housing as said means for verbally prompting.

15. The improved medical apparatus of claim 14 wherein said means for verbally indicating comprising:
means for determining a measurement or result achieved by the patient from performing the required procedure with said medical apparatus;
an audio response unit;
means for converting digital data into analog through regeneration;
a signal output unit in communication with said means for converting;
wherein audio data is successively relayed to the Signal Output unit at a rate appropriate for the regeneration of the audible response according to said medical apparatus;
means for powering said audio response unit; and
a speaker in communication with said signal output unit;
wherein an output signal corresponding to the measurement or result achieved by the patient is sent by said means for determining to the audio response unit which generates a verbal message relayed from stored audio data which is sent to the speaker to verbally indicate to the patient said measurement or result achieved and also sends a verbal functional message appropriate for the measurement or result determined according to the therapeutic function of said medical apparatus.

16. The improved medical apparatus of claim 15 wherein said audio response unit including an audio message storage unit which sends a verbal encouragement message to the speaker based on a comparison of the measurement or result achieved to a target measurement or result in relationship to said medical apparatus.

17. The improved medical apparatus of claim 15 wherein the verbal encouragement message sent is chosen from a plurality of verbal messages stored in the audio message storage unit; wherein at least one of the plurality of verbal encouragement messages is used where the measurement or result determined is lower than the target measurement or result and at least one of the plurality of verbal encouragement messages is used where the measurement or result determined is higher than the target measurement or result; wherein the plurality of verbal messages allow an appropriate verbal message to be selected according to the patient's measurement or result performance of the required procedure according to said medical apparatus.

18. An automated verbal prompting and indication device for a medical apparatus, said medical apparatus of a type that requires ancillary medical assistance to ensure or encourage use of said medical apparatus, said automated prompting device comprising:
means for verbally prompting a patient to use said medical apparatus to perform a required or recommended procedure achieved through use of said medical apparatus, wherein said verbal prompting is achieved without the physical presence of an ancillary medical assistant with the patient; and
means for verbally indicating and verbally responding accordingly to a patient based on a measurement or result achieved by the patient from the user's performance of the procedure according to said medical apparatus and without the physical presence of an ancillary medical assistant with the patient.

19. The automated verbal prompting and indication device of claim 18 wherein said means for verbally prompting comprises an electronic assembly in communication with a speaker and means for powering said electronic assembly, said electronic assembly comprising a microcontroller unit and an audio storage unit, said audio storage unit having at least one stored verbal message for prompting the patient to use said medical apparatus to perform the required procedure; wherein said microcontroller unit directs the audio storage unit to send a first verbal message to the speaker in order to prompt use of said medical apparatus device by the patient.

20. The automated verbal prompting and indication device of claim 19 wherein after the required procedure has been performed by the patient said microcontroller unit is programmed to wait for a predetermined therapeutic time period before directing said audio storage unit to send a next verbal prompting message to the patient for prompting the patient to perform another required procedure; wherein the patient is encouraged to perform multiple required procedures with said medical apparatus device during a single day period as therapeutically required or recommended.

21. The automated verbal prompting and indication device of claim 19 wherein said means for verbally indicating comprising:
means for determining a measurement or result achieved by the user from performing the required procedure with said medical apparatus;
an audio response unit;
means for powering said audio response unit; and
a speaker in communication with said audio response unit;
wherein a signal corresponding to the measurement or result achieved by the user is sent by said means for determining to the audio response unit which generates a verbal message which is sent to the speaker to verbally indicate to the user said measurement or result achieved and also sends a verbal functional message appropriate for the measurement or result determined in accordance with particular guidelines for said medical apparatus.

22. The automated verbal prompting and indication device of claim 21 wherein said audio response unit including an audio message storage unit which sends a verbal encouragement message to the speaker based on a comparison of the measurement or result achieved to a target measurement or result in accordance with said medical apparatus.

23. The automated verbal prompting and indication device of claim 22 wherein the verbal encouragement message sent is chosen from a plurality of verbal messages stored in the audio message storage unit; wherein at least one of the plurality of verbal encouragement messages is used where the measurement or result determined is lower than the target measurement or result and at least one of the plurality of verbal encouragement messages is used where the measurement or result determined is higher than the target measurement or result; wherein the plurality of verbal messages allow an appropriate verbal message to be selected according to the user's measurement or result performance of the required procedure as needed according to said medical apparatus.

24. The automated verbal prompting and indication device of claim 18 further comprising means for storing information relating to the patient's usage of said medical apparatus or to measurements or results achieved by the patient from use of said medical apparatus.

25. The automated verbal prompting and indication device of claim 24 for comprising means for transmitting the stored information to a retrieving location that is remote to whatever current location of said medical apparatus.
